(19) United States
(12) Patent Application Publication
(10) Pub. No.: US 2026/0074082 A1
(43) Pub. Date: Mar. 12, 2026

(54) COMBINED COLD AND THERMAL NEUTRON MODERATOR

(71) Applicant: MIRROTRON KFT., Budapest (HU)

(72) Inventors: Gábor SZÁSZ, Dunavarsány (HU); Ferenc MEZEI, Budapest (HU); Eszter PÓSFAYNÉ DIAN, Budapest (HU)

(21) Appl. No.: 18/870,227

(22) PCT Filed: May 30, 2023
(86) PCT No.: PCT/HU2023/050029

§ 371 Date: Nov. 27, 2024

(30) Foreign Application Priority Data
Jun. 1, 2022 (HU) P2200196

(51) Int. Cl. G21C 5/16; G21C 5/12

(52) U.S. Cl. CPC G21C 5/16; G21C 5/12

(57) ABSTRACT

The invention relates to a combined cold and thermal neutron moderator (10) having a longitudinal axis (t) and at least one neutron exit window (50) at a first end (11, 12), and a cold moderator (20) arranged along the longitudinal axis (t), a thermal pre-moderator (30) and a vacuum space (40), said thermal pre-moderator (30) having a pre-moderator mantle (32) surrounding the cold moderator (20) along the longitudinal axis (t) and separated from the cold moderator (20) by the vacuum space (40), characterized in that the pre-moderator (30) comprises a pre¬moderator collar (34) extending at least at the first end (11, 12) from the pre¬moderator jacket (32) towards the longitudinal axis (t), which substantially covers the portion of the vacuum space (40) between the cold moderator (20) and the pre¬moderator mantle (32) from the direction of the neutron exit window (50), leaving substantially free at least one end (21, 22) of the cold moderator (20) at the end (11, 12).

WO

The invention relates to a combined cold and thermal neutron moderator having a longitudinal axis and a neutron exit window at at least one end, and comprising a cold moderator, a thermal pre-moderator and a vacuum space arranged along the longitudinal axis, the thermal pre-moderator having a pre-moderator mantle surrounding the cold moderator along the longitudinal axis and separated from the cold moderator by the vacuum space.

### BACKGROUND ART

One of the most important components of modern neutron sources is the so-called moderator, which reduces the energy of fast neutrons produced in nuclear reactions to the thermal or cold energy range. Both energy ranges can be utilized for different measurements, so the purpose of use of the end devices determines the optimal slow neutron output.

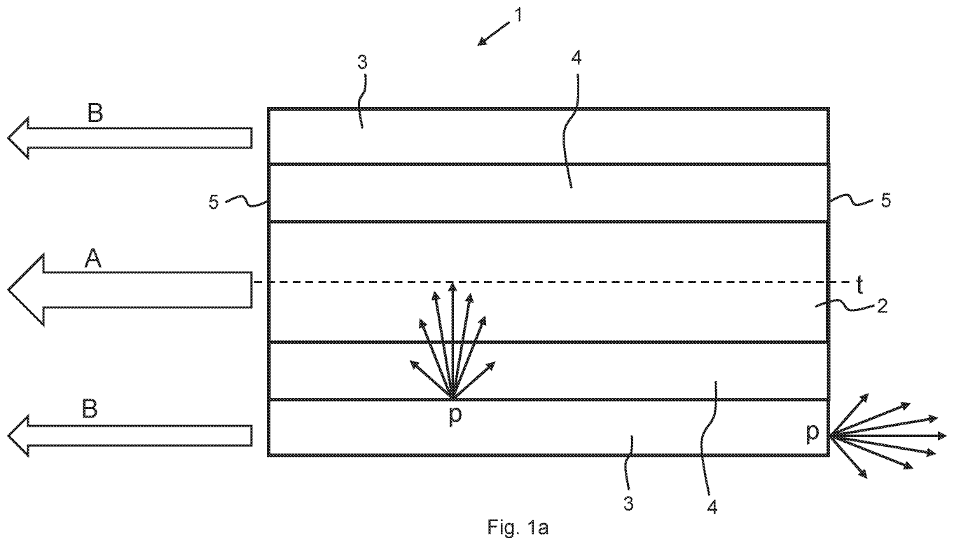

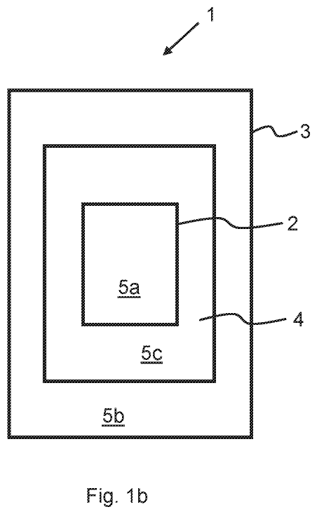

Based on previous studies (see K. Batkov, A. Takibayev, L. Zanini, F. Mezei: Unperturbed moderator brightness in pulsed neutron sources, NIM A, Vol. 729, 2013, Pp 500-505 and Tetsuya Kai, Masahide Harada, Makoto Teshigawara, Noboru Watanabe, Yujiro Ikeda: Coupled hydrogen moderator optimization with ortho/para hydrogen ratio, NIM A, Vol. 523, Issue 3,2004, pp. 398-414), one of the most advantageous moderator types for these sources in terms of neutron yield—“brightness” (n/Å/cm2/s/sr)—is the low-dimensional (2D, flat, 1D, “tube-like”) neutron moderator 1, which includes cold moderator 2 with thermal pre-moderator 3 (see FIG. 1a). In “tubular” neutron moderators 1, the medium (e.g. 20 K liquid para-H₂) of the central cold moderator 2 is surrounded by a vacuum space 4, followed by the pre-moderator 3 (e.g. room temperature water), typically formed as a pre-cooling mantle of a few cm (1-3 cm) thickness.

At each end of the neutron moderator 1 there is an exit window 5 through which neutrons can exit neutron moderator 1 and enter a neutron exit tube (not shown) parallel to the longitudinal axis of the neutron moderator 1. FIG. 1b shows neutron moderator 1 from the direction of one of the exit window 5. The exit window 5 can be divided into three nested regions: an exit window portion 5a in front of the cold moderator 2, an exit window portion 5b in front of the pre-moderator 3, and an exit window portion 5c in front of the vacuum space 4.

Such an arrangement allows for more efficient neutron beam ejection compared to higher dimensional moderator types. In addition, the pre-moderator 3 allows for multispectral neutron ejection, since cold neutrons can be ejected from the cold moderator 2 and thermal neutrons from the pre-moderator 3 in close spatial proximity.

The “primary” neutrons from the neutron source, produced in a nuclear reaction, are scattered by a sufficiently large reflector and reach the pre-moderator 3 with a nearly homogeneous directional distribution, and the neutrons thermalized here exit the pre-moderator 3 with a typically cosine directional distribution close to the normal distribution, as illustrated in FIG. 1a at the points marked with P. The neutrons colliding in and exiting from the pre-moderator 3 fall mainly in the thermal energy range, which is between about 0.025-0.3 eV energy. The actual energy range of the thermal neutrons exiting the pre-moderator 3 is determined by the material and temperature of the pre-moderator. Neutrons exiting from the surface of the pre-moderator 3 towards the cold moderator 2 usually reach the cold moderator 2, where, for example in the case of liquid para-H₂ at 20 K, they typically dissipate a significant fraction of their energy in a single collision and continue as cold neutrons. Neutrons colliding in and exiting from the cold moderator 2 fall into the cold energy range, which is between about 0.00001 and 0.025 eV. The actual energy range of the resulting cold neutrons is determined by the material and temperature of the cold moderator 2. The cold neutrons exiting from the cold moderator 2 through one of the two exit windows 5 are shown in FIG. 1a only on the left side of the neutron moderator 1 with an arrow in the middle, labeled A. The thermal neutrons leaving the pre-moderator 3 in the direction of the exit window 5 can also be channeled and utilized, which is also illustrated on the left side of FIG. 1a with the lower and upper arrows B. The useful neutron yield of the neutron moderator 1 is determined, among other things, by the size of the exit surface (Liouville's theorem).

The inventors of the present invention recognized that the vacuum space 4 separating the pre-moderator 3 from the cold moderator 2 in neutron moderator 1 represents a significant loss in cold and thermal neutron yield. One reason for this is that only a very small fraction of the neutrons exiting from the pre-moderator 3 at the surface facing the cold moderator 2 exit at a sufficiently small angle to reach exit window 5 through vacuum space 4, and in addition such thermal neutrons travel a greater distance in the tank wall of the pre-moderator 3, which is lossy due to neutron absorption in the wall. The same is true for cold neutrons exiting the cold moderator 2 at a small angle. The other reason is that the vacuum space 4 in the volume between the cold moderator 2 and the pre-moderator 3 is completely ‘blind’ as a neutron source, no neutrons come from there. Thus, the neutron beam that comes out completely lacks the neutron paths that could only come from the vacuum space 4 between the cold moderator 2 and the pre-moderator 3. Thus, a significantly lower intensity neutron emission can be expected from the vacuum space 4 around the cold moderator 2 than from the cold moderator 2 and the pre-moderator 3. Thus, the exit window portion 5c adjacent to vacuum space 4 is essentially a “dead space”.

The invention aims to provide an apparatus free from the disadvantages of prior art solutions. In particular, the invention is aimed at increasing the combined cold and thermal neutron yield of “tubular” neutron moderators.

The inventors recognized that by forming a collar around the cold neutron exit window at both ends of the neutron moderator 1 on the pre-moderator 3 that covers the vacuum space 4 exit openings, this solution could significantly increase the total neutron yield of the moderator, with unchanged cold neutron and increased thermal neutron yields, for the same total beam cross section.

Based on the above recognition, the problem is solved with a combined cold and thermal neutron moderator according to the present invention, wherein the pre-moderator comprises a pre-moderator collar extending from the pre-moderator mantle towards the longitudinal axis at least one end of the pre-moderator, which substantially covers the portion of the vacuum space between the cold moderator and the pre-moderator mantle from the direction of the neutron exit window, leaving substantially free at least one end of the cold moderator at the pre-moderator collar. Preferably, the neutron moderator has a neutron exit window at each end, and a pre-moderator collar is formed at each exit window to cover the vacuum space.

Compared to the low-dimensional moderators having pre-moderators studied so far, the innovation is the shape of the pre-moderator, which includes a pre-moderator collar around the cold neutron exit window. The function of this pre-moderator collar is to bridge the dead space caused by the vacuum space separating the cold moderator and the thermal pre-moderator, increasing the surface area of the exit window portion for thermal neutrons and thus the thermal neutron yield of the total neutron moderator. The inventors have realized that a similar exit neutron intensity can be expected from the pre-moderator collar as what can be expected from any surface of the pre-moderator mantle, for which the thickness of both the pre-moderator mantle and the pre-moderator collar should be greater than the mean free path of neutrons in the pre-moderator. In the state-of-the-art arrangement, there is little thermal or cold neutron escape from the vacuum space 4, since a very small fraction of the thermal or cold neutrons exiting the pre-moderator or the cold moderator exit at sufficiently small angles to be able to travel through the vacuum space 4 and the exit window 5, while the vacuum space as a neutron source is completely ‘blind’, having no neutron paths starting therefrom. On the other hand, further collisions in the pre-moderator collar of the invention increase the probability of neutrons exiting in the longitudinal direction, as the collisions deflect the trajectory of some of the neutrons entering the pre-moderator collar towards the exit window.

The cold moderator contains a material with a preferably energy-dependent neutron scattering probability, in which the mean free path of cold neutrons is larger than the mean free path of thermal neutrons in the cold moderator. One is preferably at least 2 times, more preferably at least 5 times, most preferably at least 10 times, than the other one.

The length of the cold moderator is preferably at least 1 times and maximum 3 times the mean free path of the cold neutrons within the cold moderator, more preferably at least 1 times and up to 2.5 times, more preferably at least 1.5 times and up to 2 times the mean free path of the cold neutrons. Preferably, the thickness of the cold moderator is at least 1 times, more preferably at least 1.5 times the mean free path of the thermal neutrons within the cold moderator.

In a particularly preferred embodiment, the cold moderator comprises para-H₂ as a material having an energy dependent neutron scattering probability. This preferably has a temperature of about 20 K.

Preferably, the pre-moderator material does not have an energy-dependent neutron scattering probability, so that the hot neutrons from the neutron source and the moderated thermal and cold neutrons have approximately the same average free path therein. This is about 1 cm in the case of room temperature water.

The thickness of the pre-moderator mantle and the pre-moderator collar is preferably chosen to be at least 1 times, preferably at least 1.5 times the mean free path in the pre-moderator material.

According to a further preferred embodiment, the pre-moderator extends beyond the cold moderator in both directions along the longitudinal axis, and the longitudinal position along the longitudinal axis of both pre-moderator collars is between the end of the cold moderator and the exit window.

Preferably, the longitudinal distance of both pre-moderator collars from the end of the cold moderator adjacent to it is 0.5-2 mm, preferably about 1 mm. Such a vacuum gap already provides sufficient thermal insulation between the cold moderator and the thermal pre-moderator.

Further details of the invention will be explained with the help of a drawing using examples. It is in the drawing

FIG. 1a is a schematic cross-sectional view of a state-of-the-art neutron moderator along the longitudinal axis;

FIG. 1b is a schematic view of the neutron moderator according to FIG. 1a from the direction of one of the neutron exit windows;

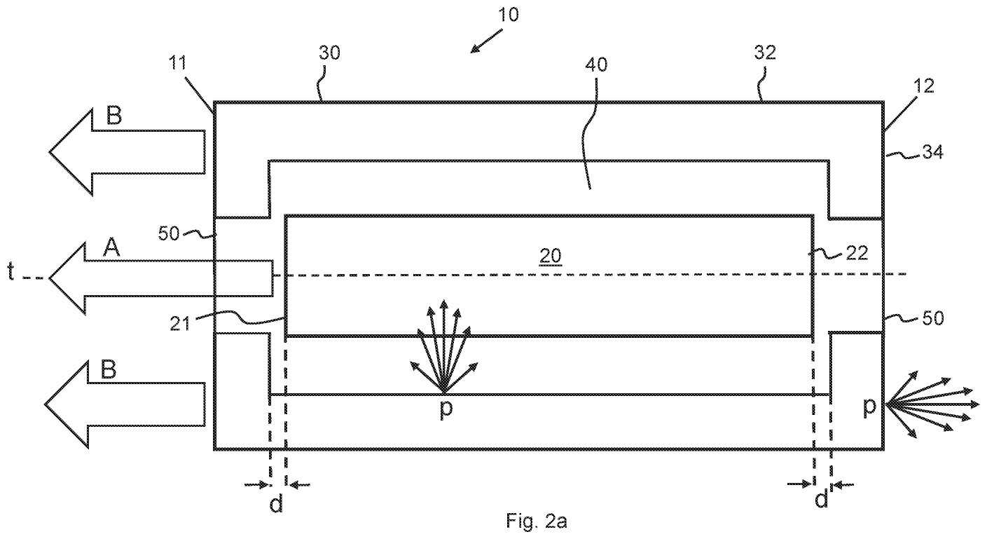

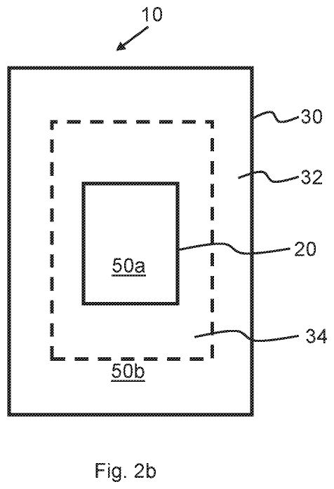

FIG. 2a is a schematic cross-sectional view of an exemplary neutron moderator according to the invention along the longitudinal axis;

FIG. 2b is a schematic view of the neutron moderator according to FIG. 2a from the direction of one of the neutron exit windows;

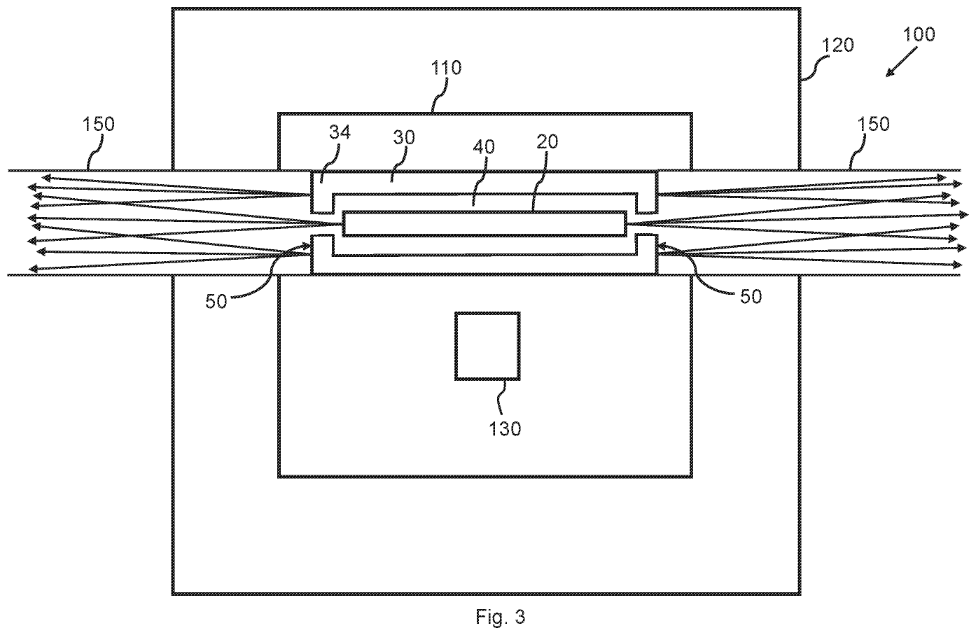

FIG. 3 shows a possible arrangement of the neutron moderator according to 2a and 2b within an exemplary neutron source.

FIGS. 2a and 2b show a combined cold and thermal neutron moderator 10 according to the invention. The neutron moderator 10 comprises a cold moderator 20, a thermal pre-moderator 30, and a vacuum space 40 arranged along a longitudinal axis t. In the present embodiment, both ends 11 and 12 of the neutron moderator 10 serve as neutron exit window 50. By contrast, an embodiment is also possible in which only one of the ends 11 or 12 of the neutron moderator 10 serves as an exit window 50, i.e., the moderated neutron beam is coupled from here. In this case, the other ends 11, 12 of the neutron moderator 10 do not have an opening on the pre-moderator 30 for the cold neutrons to exit, instead, the pre-moderator 30 covers the cold moderator 20.

In FIGS. 2a and 2b, the pre-moderator 30 has a pre-moderator mantle 32 surrounding the cold moderator 20 along the longitudinal axis t, separated from the cold moderator 20 by the vacuum space 40. Within the pre-moderator 30, the cold moderator 20 can be fixed in the usual way by means of insulating spacers, which are not shown in the figures.

At each end of the pre-moderator mantle 32 there is a pre-moderator collar 34 extending in the direction of the longitudinal axis t, which also forms part of the pre-moderator 30. The pre-moderator collars 34 are dimensioned to substantially cover the portion of the vacuum space 40 between the cold moderator 20 and the pre-moderator mantle 32 from the direction of the exit windows 50, and to substantially leave the ends 21, 22 of the cold moderator 20 free. Preferably, this is achieved by having the pre-moderator 30 extend beyond the cold moderator 20 in both directions along the longitudinal axis t, and the position of both pre-moderator collars 34 along the longitudinal axis t is such that they are between the ends 21, 22 of the cold moderator 20 nearest thereto and the exit window 50 nearest thereto. Thus, both pre-moderator collars 34 are positioned outwardly relative to the cold moderator 20, allowing the pre-moderator collar 34 to extend all the way to an exit window portion 50a adjacent to the ends 21, 22 of the cold moderator 20, as can be seen in FIG. 2b, where the junction of the pre-moderator collar 34 and the pre-moderator mantle 32 is indicated by a dashed line. In such a case, both exit windows 50 can therefore be split into two portions: an exit window portion 50a adjacent to the respective end 21 or 22 of the cold moderator 20 and an exit window portion 50b outside of it, adjacent to the thermal pre-moderator 30. Both pre-moderator collars 34 are at a distance d along the longitudinal axis t from the end 21 or 22 of the cold moderator 20 closer to it. The distance d is preferably 0.5 to 2 mm, more preferably about 0.8 to 1.2 mm, for example about 1 mm. There is thus a vacuum filled gap between the inner side of the cold moderator 20 and the pre-moderator collars 34, so that no heat conduction occurs between the lower temperature cold moderator 20 and the higher temperature pre-moderator 30.

In the present embodiment, the cross-section of the “tubular” neutron moderator 10 is rectangular, but of course other cross-sections are possible (e.g. square, circle, etc.)

Preferably, the pre-moderator 30 contains water at room temperature (around 20-24 degrees Celsius), but during use the temperature can rise to 30-35 degrees Celsius even when the water is circulating. In this medium, the high-energy hot neutrons collide within a few mm, dissipate most of their energy and leave the pre-moderator 30 mainly in the thermal energy range. Preferably, the pre-moderator 30 is configured as a single-space container with the pre-moderator mantle 32 and the pre-moderator collar 34 opening into each other. The wall of the tank may be made of any commonly used material, such as 2-3 mm thick aluminium alloy or zirconium alloy (for example, a material marketed as Zircaloy).

The material filling the cold moderator 20 has a preferentially energy-dependent neutron scattering probability, which means that the average free path of neutrons in the material of the cold moderator 20 depends on the energy of the neutrons. The average free path is the average distance that a moving particle (in this case a neutron) will travel before its direction of travel or energy changes significantly as a result of a collision with other particles (in this case with particles in the material of cold moderator 20 and in pre-moderator 30 with particles forming the material of the pre-moderator 30).

The energy-dependent neutron scattering probability of the material of the cold moderator 20 is preferentially such that the mean free path of cold neutrons in the material of the cold moderator 20 is greater than the mean free path of thermal neutrons from the pre-moderator 30. Preferably, the mean free path of the cold neutrons in the material of the cold moderator 20 is at least 2 times, more preferably at least 5 times, most preferably at least 10 times, that of the thermal neutrons.

In a particularly preferred embodiment, the cold moderator 20 comprises para-H₂ of about 15-40 K, preferably about 20 K, maintained in the desired temperature range by technologies known per se. In this liquid para-H₂ medium, the mean free path of thermal neutrons from the room temperature pre-moderator 30 is about 1 cm, while the mean free path of cold neutrons is about 10 cm. The wall of the cold moderator 20 is typically 2-3 mm thick and can be, for example, an aluminium alloy or a zirconium alloy (e.g. a material marketed as Zircaloy).

The energy-dependent neutron scattering probability of the material of the cold moderator 20 can be exploited such that the length of the cold moderator 20 is at least 1 times and at most 3 times the mean free path of the cold neutrons along the longitudinal axis t of the neutron moderator 10, preferably at least 1 times and at most 2 times, more preferably about 1.5-2 times. Cold neutrons are defined here as neutrons with energies that have already cooled down by colliding with the material of the cold moderator 20, i.e. with kinetic energies below about 50 K.

In contrast, the thickness of the cold moderator 20 perpendicular to the longitudinal axis t is preferably at least 1 times, more preferably about 1.5 times or greater than the mean free path of the thermal neutrons coming from the pre-moderator 30 in the cold moderator 20. Thus, using para-H₂ with a temperature of about 20 K as cold moderator 20 and room temperature water as pre-moderator 30, the length of the cold moderator 20 is preferably about 10-20 cm and the thickness is preferably about 1-2 cm. The thickness of the cold moderator 20 means the width perpendicular to the longitudinal axis t. This may be different depending on the direction in which it is measured perpendicular to the longitudinal axis t. For example, in the embodiment shown in FIG. 2b, the rectangular cross-section cold moderator 20 has two thicknesses (in the vertical and horizontal directions as shown). Preferably, both thicknesses fall within the given ranges.

In contrast, the material of the pre-moderator 30 does not have an energy-dependent neutron scattering probability, i.e. both thermal and cold neutrons, and even hot neutrons, have the same mean free path. The thickness of the pre-moderator mantle 32 and the pre-moderator collar 34 is adapted to this mean free path, the thickness is preferably at least 1 times, more preferably at least 1.5 times this mean free path.

FIG. 3 illustrates an exemplary arrangement of the neutron moderator 10 according to the invention, in an exemplary neutron source 100.

The neutron source 100 contains a target 130 surrounded by a reflector 110 and beam shielding 120 (e.g. concrete wall), connected to a proton beam channel from outside (not shown). A proton beam in the energy range of 2-100 MeV can be guided through the proton beam channel to the target 130, for example lithium or beryllium, so that predominantly fast neutrons in the neutron energy range of about 100 keV-100 MeV are produced when protons entering the proton beam channel collide with nuclei of the target 130.

The neutron moderator 10 according to the invention is located inside the reflector 110, and the two exit windows 50 are each connected to an exit channel 150 through which moderated cold and thermal neutrons can exit. Thanks to the reflector 110, fast neutrons generated in the target 130 enter the neutron moderator 10 from approximately all directions with approximately the same intensity through the pre-moderator mantle 32.

The exit window portion 50a of the neutron moderator 10 in front of the cold moderator 20 is preferably not sealed, instead there is also vacuum within the exit channel 150, which is in connection with the vacuum space 40 within the neutron moderator 10 through the exit window portion 50a. However, an other embodiment is also conceivable wherein the neutron moderator 10 is sealed at the exit window portion 50a by a 2-3 mm thick wall made of, for example, aluminium alloy or zirconium alloy (for example, a material sold under the trade name “Zircaloy”).

Within the neutron source 100, the pre-moderator 30 can have a dual role: on the one hand, it thermalizes the incoming fast (or partially thermalized) neutrons, thus improving the cold neutron yield of the cold moderator 20. On the other hand, together with the vacuum space, it also acts as a thermal insulator between the target 130 and the neutron moderator 10, or shields the cold moderator 20 from the energetic particle and thermal radiation exiting the target 130.

Most of the thermal neutrons leaving the room temperature water filling the pre-moderator 30 are slowed down to cold neutrons near the outer walls of the cold moderator 20 in the liquid hydrogen filling the cold moderator 20 (e.g. 20 K liquid para-H₂).

In the cold moderator 20, the thermal neutrons from the pre-moderator 30, having a mean free path of about 1 cm, lose most of their kinetic energy in one collision. The resulting cold neutrons have a mean free path of about 10 cm in para-hydrogen, i.e., the cold neutrons can exit the preferably 10-20 cm long cold moderator 20 through the exit window portions 50a of the exit windows 50 adjacent to the cold moderator 20 towards the neutron beam 150 exit channels, without any change of direction, thus ensuring the formation of an equilibrium cold neutron flux. Therefore, to achieve the optimum cold neutron intensity along the longitudinal axis t, cold para-hydrogen is preferably required at a depth of 10-20 cm. This therefore determines the size of the cold moderator 20 in the direction of the outgoing beam, i.e. the length of the cold moderator 20 along the longitudinal axis t. In contrast, the mean free path of the thermal neutrons produced in the pre-moderator 30 filled with room temperature water is only a few mm, so that even a 1.5 cm thick water mantle is sufficient to couple out the equilibrium thermal neutron flux. Thus, a uniform thermal neutron flux can be expected from the entire exit window portion 50b enlarged by the pre-moderator collar 34. With this solution, the total neutron yield of the neutron moderator 10 can be increased, with unchanged cold neutron and increased thermal neutron yield.

It is noted here that since the cold neutrons and thermal neutrons do not exit through the exit window 50 strictly parallel to the longitudinal axis t, the cold and thermal neutrons are mixed in the exit channel 150, as illustrated in FIG. 3.

Various modifications to the above disclosed embodiments will be apparent to a person skilled in the art without departing from the scope of protection determined by the attached claims.

1. Combined cold and thermal neutron moderator (10) having a longitudinal axis (t) and a neutron exit window (50) on at least a first end (11, 12), and comprising a cold moderator (20), a thermal pre-moderator (30) and a vacuum space (40) arranged along the longitudinal axis (t), said thermal pre-moderator (30) having a pre-moderator mantle (32) surrounding the cold moderator (20) along the longitudinal axis (t) and being separated from the cold moderator (20) by the vacuum space (40), characterized in that the pre-moderator (30) comprises at least at the first end (11, 12) a pre-moderator collar (34) extending from the pre-moderator mantle (32) towards the longitudinal axis (t), which pre-moderator collar (34) substantially covers a portion of the vacuum space (40) between the cold moderator (20) and the pre-moderator mantle (32) from a direction of the neutron exit window (50), leaving substantially free at least an end (21, 22) of the cold moderator (20) at the first end (11, 12).

2. The neutron moderator according to claim 1, characterized in that the cold moderator (20) comprises a material having an energy-dependent neutron scattering probability, wherein a first mean free path of cold neutrons moderated in the cold moderator (20) is greater than a second mean free path of thermal neutrons moderated in the pre-moderator (30), preferably at least 2 times, more preferably at least 5 times, most preferably at least 10 times greater.

3. The neutron moderator according to claim 2, characterized in that the length of the cold moderator (20) is at least 1 times and maximum 3 times, preferably at least 1 times and maximum 2.5 times, more preferably at least 1.5 times and maximum 2 times the first mean free path of the cold neutrons, and the thickness of the cold moderator (20) is at least 1 times, preferably at least 1.5 times the second mean free path of the thermal neutrons.

4. The neutron moderator according to claim 2 or 3, characterized in that the cold moderator (20) comprises para-H₂ as the material having the energy dependent neutron scattering probability.

5. The neutron moderator according to any one of claims 1 to 4, characterized in that the thickness of the pre-moderator mantle (32) and the pre-moderator collar (34) is at least 1 times, preferably at least 1.5 times a third mean free path of neutrons in a material of the pre-moderator (30).

6. The neutron moderator according to any one of claims 1 to 5, characterized in that the pre-moderator (30) extends beyond the cold moderator (20) along the longitudinal axis (t) at least at the first end (11, 12), and here a position of the pre-moderator collar (34) along the longitudinal axis (t) is between the end (21, 22) of the cold moderator (20) and the neutron exit window (50).

7. The neutron moderator according to claim 6, characterized in that a distance (d) of the pre-moderator collar (34) from the neighboring end (21, 22) of the cold moderator (20) along the longitudinal axis (t) is 0.5-2 mm, preferably about 1 mm.

8. The neutron moderator according to any one of claims 1 to 7, characterized in that it comprises a neutron exit window (50) at each end (11, 12) of the neutron moderator, and the pre-moderator (30) has a pre-moderator collar (34) at each end (11, 12) extending from the pre-moderator mantle (32) towards the longitudinal axis (t), each pre-moderator collar (34) substantially covers a portion of the vacuum space (40) between the cold moderator (20) and the pre-moderator mantle (32) from a direction of the neighboring neutron exit window (50), leaving the two ends (21, 22) of the cold moderator (20) substantially free.
